(19) United States
(12) Patent Application Publication
(10) Pub. No.: US 2014/0307267 A1
(43) Pub. Date: Oct. 16, 2014

(54) Measuring Device

(71) Applicant: H and S Industries, Spring Grove, IL (US)

(72) Inventor: William Joseph Hoth, Jr., Johnsburg, IL (US)

(73) Assignee: H and S Industries, Spring Grove, IL (US)

(21) Appl. No.: 14/247,999

(22) Filed: Apr. 8, 2014

Related U.S. Application Data
(60) Provisional application No. 61/810,607, filed on Apr. 10, 2013.

(51) Int. Cl. G01B 11/28; G01B 11/14

(52) U.S. Cl. CPC G01B 11/28; G01B 11/14
USPC 356/628

(57) ABSTRACT

A measuring device having a first set of illumination sources including respective first and second illumination sources for measuring a first distance; a second set of illumination sources including respective first and second illumination sources for measuring a second distance, a first support for the first set of illumination sources, a second support for the second set of illumination sources wherein defining a first distance with said first set of illumination sources defines a second distance with the second set of illumination sources.

### FIELD OF THE INVENTION

This invention relates generally to measuring distance across a work piece. More specifically, the invention relates to defining a second distance or successive area through the measurement of a first distance or area using a pre-determined relationship within the measuring device between the first distance and the second distance.

### BACKGROUND OF THE INVENTION

Matching colors, shades and tones has always been a challenge. Whether one is refinishing and re-staining an oak floor or patching a painted surface that has been damaged or worn by the ambient environment, the objective of the refurbishing activity is to give the work piece a “like new” look.

The provision of a true match can be especially problematic where re-coloring the entire surface of the work piece, for example, by painting is either undesirable or impossible. In these instances, care has to be taken to match the shade or color of the new coating to that of the coating already on the surface to be refurbished.

One environment where color matching is a daily challenge is in the repair of vehicles. Regardless of whether the vehicle has been subjected to a collision or has become a receptacle for the bumps, dings and fading that occur with routine use, the process of repairing or refurbishing usually concludes with repainting the vehicle.

As previously discussed, with routine vehicle repairs, the usual practice is to paint only the portion of the vehicle which has been repaired. Matching paint color is essential to customer satisfaction and preserving the market value of the vehicle.

This is not the only application where the partial replacement of a surface coating has definite criticalities. Repairing high-line vehicles in specialized shops, working with paint manufacturers, testing and refining products, as well as putting standard operating procedures in place to make business more profitable are all aspects of industrial surface treatment which require measurement and optimization. Additionally, the repair or refurbishment of any painted, stained, varnished or aesthetically treated surface may present similar concerns.

Returning to the restoration of damaged vehicles, the common practice is for the body shop and the insurance company estimator to work together to determine the extent of work necessary to return the auto to a “like new” condition. Part of that work is the painting of repaired vehicle.

To this end, the shop owner or estimator needs to determine how much paint blending room they need to blend color when painting a panel. Paints differ as do surfaces from new to repaired. The shop owner or estimator may also have to contend with different directions on blending from the insurance adjuster. In short, there is no set standard on the manner in which the intended area or working surface is determined for repair and refurbishing.

Color needs to be blended. When a vehicle gets damaged and ends up in a collision repair facility, the first step is to look over the vehicle and build an estimate. After the estimate is approved, parts are ordered and the repairs begin. Once the body work is finished, the vehicle goes into the paint department. The painter pulls the paint code off the vehicle and puts it into the paint computer. The computer will tell the painter what colors to mix to get the correct color of the vehicle. However, when the color is made at the collision facility it often does not match the original vehicle color exactly due to color variation on the working surface. Color variations are caused by many things at the manufacturer's level such as temperature, humidity, and equipment used in manufacturing plants. The same model and make of automobile may be made in two different countries or states for use in disparite environments. Mixing and painting may differ from one vehicle to another. Vehicle age and exposure to the environment will change the color of a vehicle as well. For example, the finish on a car in California may differ from the finish on a car in New York City. For these reasons and many more, the collision repair facility needs to blend the new color into the existing color to provide an undetectable match.

Generally the larger the damage on any surface, the more blending area is needed for an acceptable repair. For example, a dent that is 14 inches in diameter may require color to be blended over a greater area than a smaller dent of 3 or 4 inches. There is no standard operating procedure for measuring or determining blending area for, among other reasons, measuring blending distance quickly and accurately given the size of the damage.

Prior solutions for paint restoration include Lowery, U.S. Pat. No. 6,536,978 which discloses a method and device for touching up scratches and chips in automotive paint finish. Kronenwetter, U.S. Pat. No. 5,851,583 discloses a process for blending paints to match an existing finish by using two color impacting components which are reduced and then applied to the intended surface.

Measuring instruments have also been used for the application of finishes, such as paint to work pieces. For example, Baioff et al, U.S. Pat. No. 6,378,220 disclose an industrial process for the application of paint incorporating a measuring tool for use in a paint tunnel.

Lasers have also been used from time to time to assist in the application of paint finishes. For example, Klein, I I et al., U.S. Pat. No. 5,868,840 discloses a paint gun which incorporates a laser.

However, a need still exist for a devices and methods which will assist in blending and priming newly applied surface coating to an existing coating previously applied to the same surface.

### SUMMARY OF THE INVENTION

In accordance with a first aspect of the invention, there is provided a measuring device comprising a first set of illumination sources comprising respective first and second illumination sources for measuring a first distance; a second set of illumination sources comprising respective first and second illumination sources for measuring a second distance; and a support for the illumination sources. By defining the first distance with the first set of illumination sources the device defines a second distance with the second set of illumination sources.

In accordance with a further aspect of the invention, there is provided a method of determining a coating protocol using an area of damage, the method comprising the steps of measuring the area of damage; finding the primer area based on the area of damage; and finding the color blending area based on the area of damage.

In accordance with still another aspect of the invention, there is provided a method of determining a painting protocol using a measuring device. The method comprises the steps of measuring an area using that measured area to find a maximum primer area and a maximum color blending area; wherein the primer and color blending area are determined through illumination by a first set of lasers which illuminate the area of damage; by a second set of lasers which illuminate the primer area; and by a third set of lasers which illuminate the color blending area.

### BRIEF DESCRIPTION OF THE FIGURES

FIG. 1A is a top plan view of a measuring device showing, in hidden lines, six channels for containing lasers in accordance with one embodiment of the invention and the angles of these channels from axis Z-Z¹.

FIG. 1B is a side elevational view of a measuring device showing, the opening of six channels for containing lasers in accordance with one embodiment of the invention as shown in FIG. 1A.

FIG. 1C is a bottom plan view of the blending ruler depicted in FIG. 1A.

FIG. 2A is a top plan view of a blending ruler base and support showing channels for containing laser in accordance with a further embodiment of the invention.

FIG. 2B is a front elevational view of the blending ruler depicted in FIG. 2A.

FIG. 2C is a perspective view of the base and support portions, showing the channels, in the blending ruler depicted in FIG. 2A.

FIG. 3A is a perspective view of the blending ruler in accordance with an even further embodiment of the invention.

FIG. 3B is a perspective view of the housing base and support containing lasers positioned in the housing base channels of the blending ruler depicted in FIG. 3A.

FIG. 3C is a top plan view of the blending ruler depicted in FIG. 3A, showing, in hidden lines, the housing base and support having channels with lasers positioned therein as well as an on-off switch.

FIG. 4A is a top plan view of a support in accordance with yet another embodiment of the measuring device of the invention.

FIG. 4B is a side elevational view of the support depicted in FIG. 4A.

FIG. 4C is a perspective view of the support depicted in FIG. 4A.

FIG. 4D is a top plan view of a further embodiment of the measuring device of the invention showing, in hidden lines, the support (depicted in FIG. 4A), battery power sources, laser illumination sources contained within the support and the pathways of the laser illumination sources exiting the device of the invention through respective side wall openings.

FIG. 4E is a side elevational view of the measuring device depicted in FIG. 4D without the laser pathways.

FIG. 4F is a perspective view of the measuring device ruler depicted in FIG. 4D with, as shown, the upper portion of the housing removed exposing the battery power source, support, lasers, laser pathways and side wall openings.

FIG. 5 is a top plan view of a still further embodiment of the measuring device of the invention.

FIG. 6 is a schematic depiction of application of one embodiment of a measuring device in accordance with the invention.

FIG. 7 is a side elevation of a depiction of the application of a further alternative embodiment of a measuring device in accordance with the invention.

### DETAILED DESCRIPTION OF THE INVENTION

In accordance with the invention and as depicted throughout several views in the Figures, there is provided a measuring device comprising a housing having a base portion, a top portion and a sidewall. The sidewall has one or more openings. Within the housing, there is positioned a support having channels and one or more lasers positioned in the channels.

The invention also provides a refurbishing or refinishing protocol using an optical measuring device. The method comprises the steps of measuring the area of damage and using that measured area of damage to find the maximum color blending area. The color blending area is preferably determined through laser illumination by a first set of lasers which illuminate the outer boundary of damage on the working surface. A second set of lasers may be used to illuminate the area for applying primer. A third set of lasers may be used to illuminate and define the color blending area.

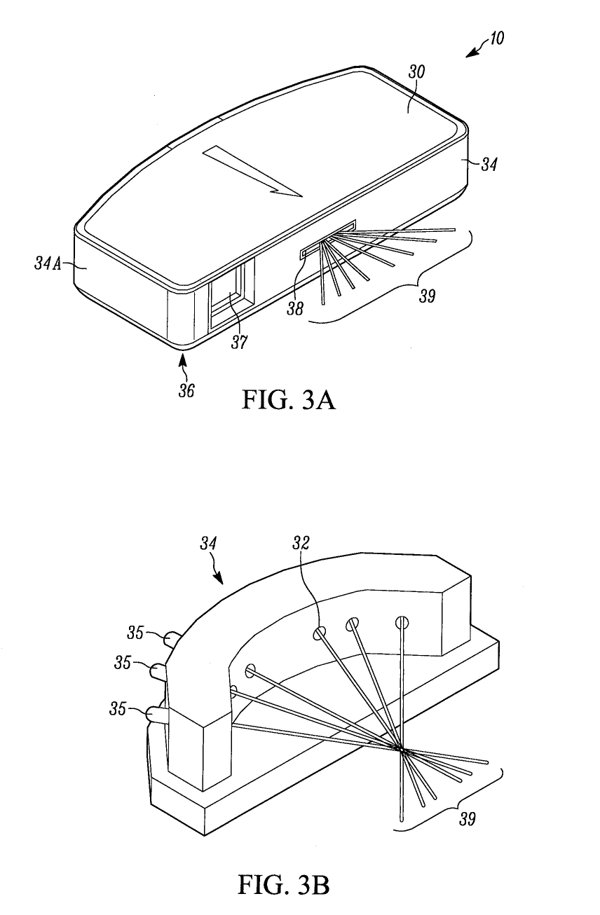

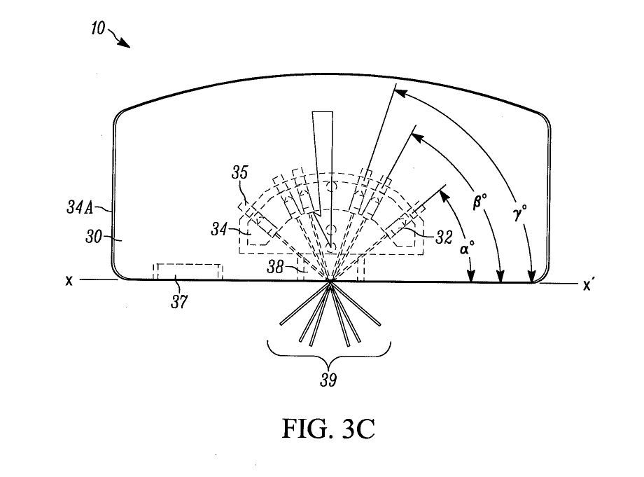

The invention generally comprises a housing 10, FIG. 3A having a top portion 30 and a bottom portion 36. The top and bottom portions fit together through any number of conventional means and may have a wall 34 interposed between them. The housing functions to protect the individual components of the measuring device as well as provide a stable platform for use of the device as well as provide a stable platform for use of the device including facilitating its application in any number of environments. Consistent with these functions, the housing may take any number of configurations and be made from any number of materials.

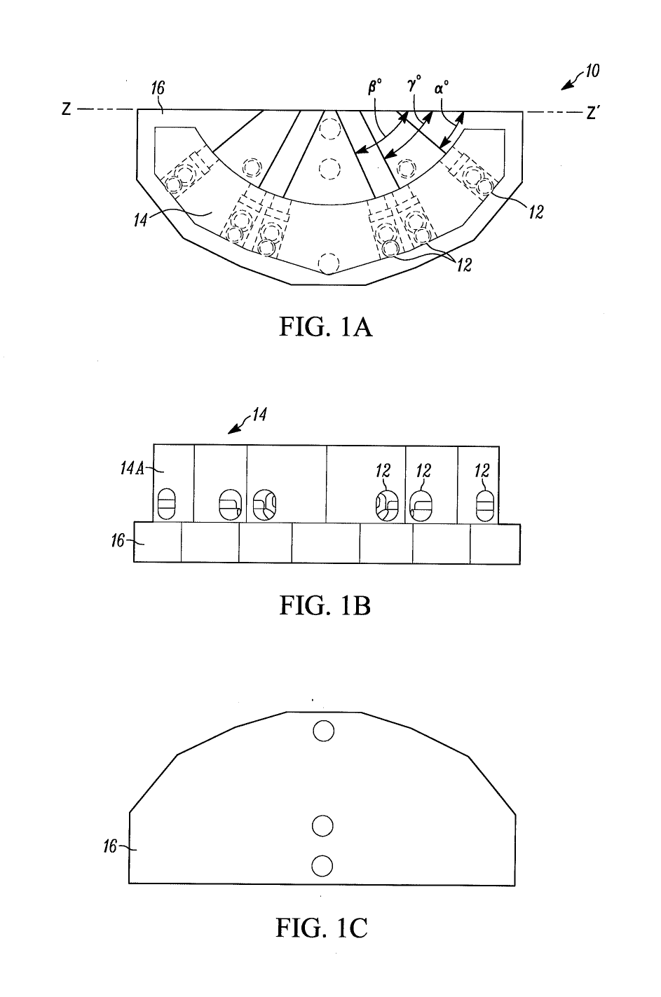

In specific, as can be seen FIGS. 1A and 1B, the housing base portion 16 may have channels 12 formed in the support 14. The channels 12 open from the support wall 14A. The housing may be closed or sealed by attachment of a housing upper portion 30, (shown in FIG. 3A). The housing may be any number of materials. Preferably the housing is fabricated from T 60/61 aluminum. Any other suitable alloy or polymeric material may also be used which provide the necessary structural integrity to the device.

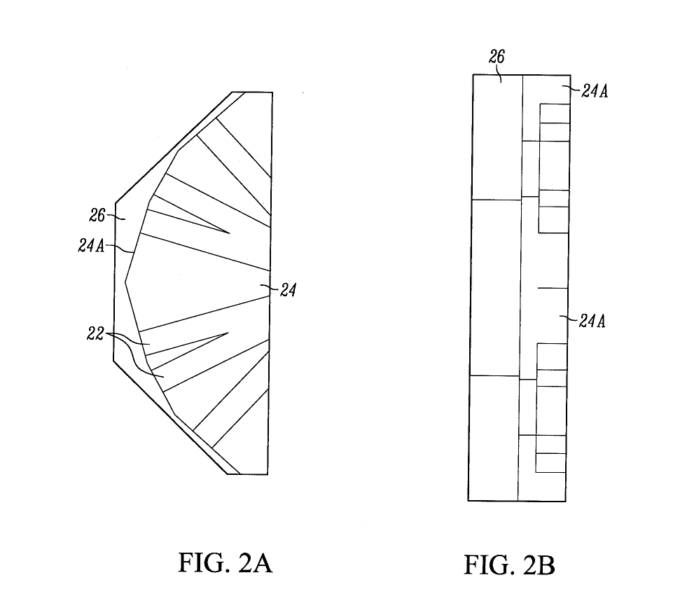

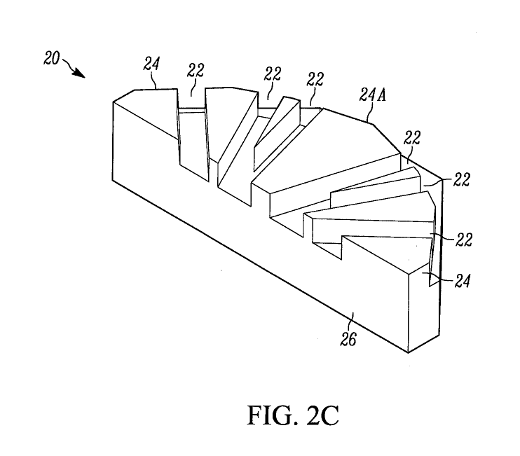

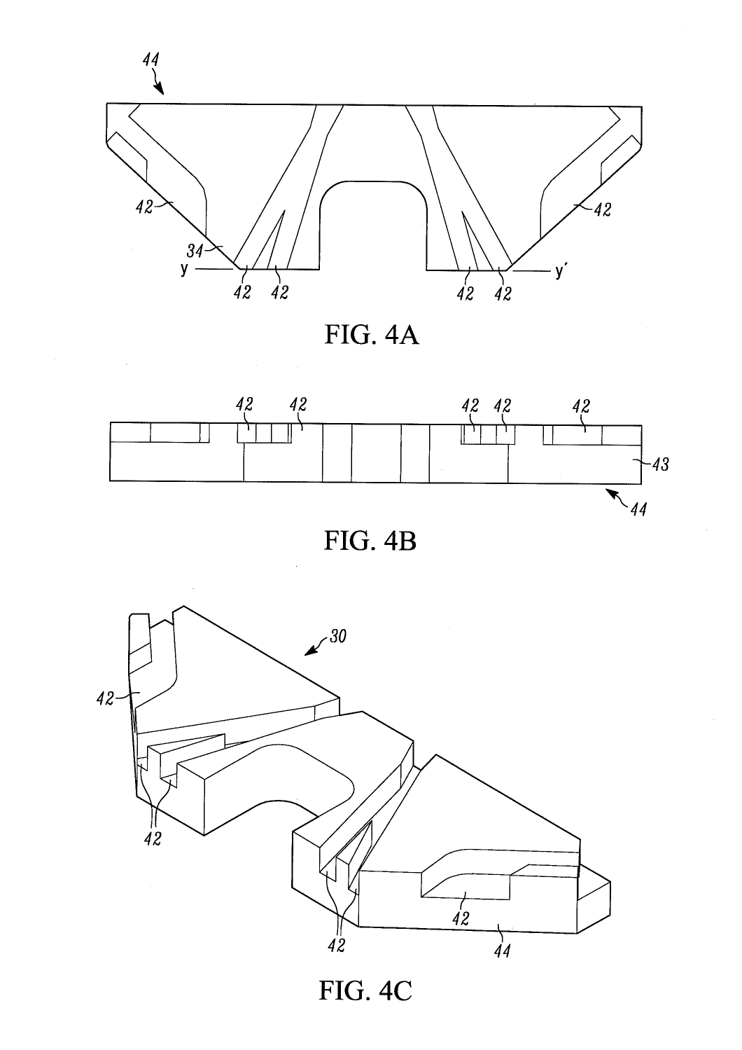

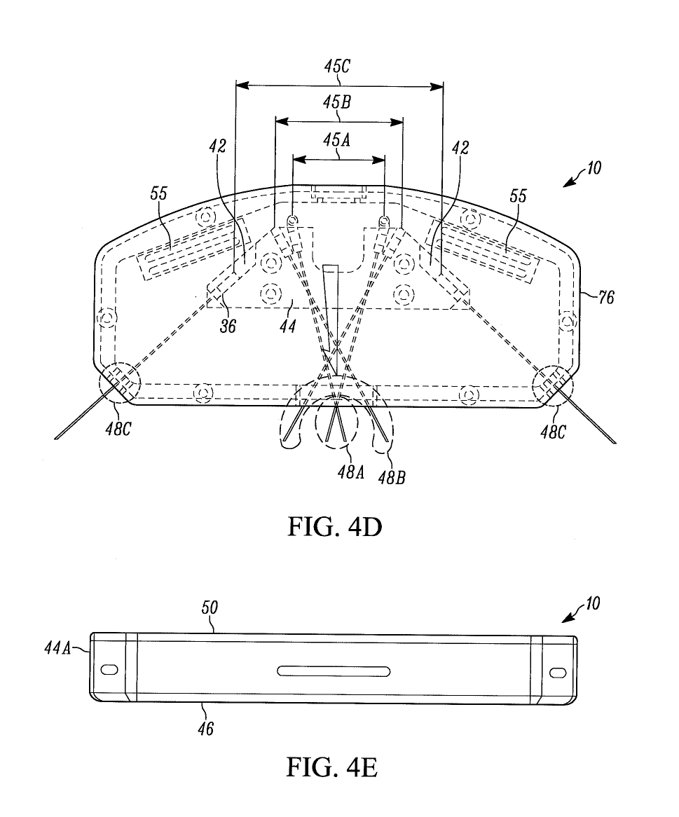

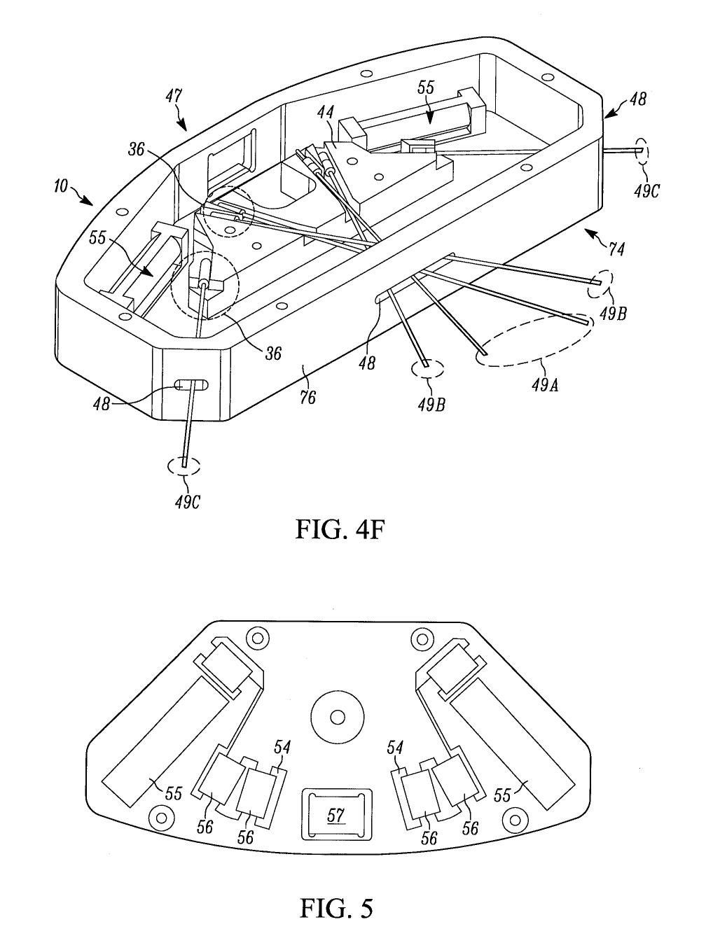

The invention may also comprise a support 14, FIGS. 1A and 2A. The support 14 functions to hold, protect and direct the illumination sources of the invention used to mark or define the respective distances. The support 14 may be affixed to the housing base 16, FIGS. 1A, 1C and 4F. Alternatively, the support 14 may be formed integrally into the housing base 16, FIG. 2D. Further a separate support may be used for each individual source of illumination or group of illumination sources. Alternatively, the support may be monolithic, containing all sources of illumination, for example FIG. 2C.

As can be seen in the various embodiments shown in the Figures, the support 14 generally has at least two and more preferably at least four, or even more, angled channels 12, FIG. 1A. The channels 12 function to hold and direct the sources of illumination. The sources of illumination are angled relative to one another.

Preferably, the relative channel angles (alpha α°, beta β°, gamma γ°)(FIG. 1A) are configured so that the illumination sources are directed towards a working surface and adjusted to illuminate the outer edges of the damaged, discolored, or otherwise intended area of restoration for the working surface. The outer sources of illumination identify or mark the outer edge of area in which the newly applied surface treatment, coloring, shading, staining, etc., may be matched with the existing surface treatment, FIG. 1A. Depending upon the working surface to be treated, the angle of the channels may be adjusted to provide color blending over increasing or decreasing areas.

A further set of lasers or further sources of illumination may also be used to define primer distances. This added source of illumination is most readily seen in FIG. 4D as lasers 45B with pathways 48B. In accordance with a further embodiment of the invention, more than two sources of illumination may be used to define respective distances or areas of illumination. For example, four sources of illumination may be used to define respective upper and lower edges on either side of the damaged area, FIG. 7. Here again, by defining this first distance, or area, (78A) the measuring device of the invention may be used to define the additional blending distance 78C as areas which can guide refurbishing primer or blending area. In this instance a primer area is not shown but may easily be incorporated to indicate the area of primer application.

The invention also comprises at least two, and more preferably at least four, or even more, sources of illumination 35, see FIGS. 3A-3C. The function of the source of illumination is to identify the various positions on the working surface, for example, which border the outer edges of damage or discoloration as well as the outer edges of the necessary painting or staining.

Any beam of light emitted from an ordinary source such as an incandescent, halogen, or laser light source, among other may be used consistent with the invention. Preferably, the light source provides a beam area which is a discrete point, visible on the working surface. Preferably, the focused beam is of discrete size so as to provide delineation of the various areas of concern, for example, the damaged area and the area of blending. Any source of illumination may be used consistent with the invention. Lasers are generally preferred given the lower requirements for power. Generally, useful lasers include those sold at Insta-Park of California. Lasers used in the invention include those having optical line power of 1.8 to 2.8 milliwatts, as well as 20-40 milliamps, and 3 volts. Other useful lasers include lasers provided by laser components, U.S. A. Inc. such as laser module LC-LMD-650-12.

A first embodiment of the base and support of the invention is depicted in FIGS. 1A through 1C. As can be seen, the optical measuring device 10 has a housing base portion 16 (FIG. 1C) and a support 14. The support 14 may have one or more channels 12. The channel 12 may take any shape or size commensurate with their function. The channels 12 function to position, fix and protect the sources of illumination used to indicate point(s) between which distances are measured. The channels 12 are generally open to the outer wall 14A of support 14 in this depicted embodiment. Through these channel openings, the light generated by the sources of illumination, exits the optical measuring device 10 and may otherwise impinge or become incident with the working surface (not shown) upon which measurements are to be taken.

The support and device base may be separate pieces (FIGS. 1A-1C) formed separately and later affixed to each other or alternatively formed as a monolithic structure (FIGS. 2A-2C). The individual illumination sources may be held by a single support 14 or multiple supports holding individual illumination sources or discrete groups of sources of illumination, (not shown).

Another embodiment of the invention is shown in FIGS. 2A through 2C. In this embodiment, the housing base portion 26 and support 24 are formed as one piece with channels 22 formed in the support 14. FIG. 2A shows the underside of the base portion 16 with the support 24 and channels 22 defined in hidden lines.

The support 24 has channels 22 with openings onto the support outer wall 24A of the support 24. As with the embodiment of the inventive support 14 shown in FIG. 1A, six channels are provided for containment of six individual lasers (not shown). FIG. 2A shows the top side of the base portion 26 of this embodiment of the invention with the support 24 having channels 22 defined therein. A front elevational view of the base portion 26 and support 24 is depicted in FIG. 2B with channel 22 openings incident to sidewall 24A visible. FIG. 2C is a perspective view of this embodiment of the invention depicting the base portion 26 with the support 24 having channels formed therein, the channels 22 opening on the sidewall 24A of the device.

FIGS. 3A through 3C depict a further embodiment of the invention. As can be seen the device base portion 36 is bordered by an adjacent side wall 34A. The sidewall 34A has one or more openings 38 which allow the sources of illumination 39 to exit the device 10 and otherwise impinge on the working surface (not shown). A switch 37 may be used to power on the device. Power sources such as conventional direct current or alternating current sources may be used to provide power to the device. An upper or top portion 30 may be used to close the device 10 and otherwise protect the internal contents of the measuring device of the invention, FIG. 3A.

A further embodiment of the support 34 of invention is depicted in FIG. 3B. Channels 32 containing sources of illumination 35 are angled in a manner which provides discrete beams of illumination at pre-determined angles to create respective pre-determined distances on the intended working surface (not shown).

FIG. 3C is a top elevational view of the embodiment of the invention depicted in FIG. 3A showing the support 34 in hidden lines. As can be seen, the support 34 is shown in hidden lines. As can be seen, the support 34 contains channels 32 which house sources of illumination 35. Illuminating beams 39, generated by respective sources 35, exit the device 10 out of an opening 38 in sidewall 34A.

An even further embodiment of the invention is depicted in FIGS. 4A through 4F. As can be seen in FIG. 4A, a support 44 is shown having channels 42 formed therein. The channels 42 have openings which are incident to the sidewalls 43 of the support 44, FIG. 4B. In perspective, (FIG. 4C), it can be seen that the channels 42 may be angled to provide relative distances on the working surface (not shown).

FIG. 4D depicts the fully functional optical measuring device of the invention, using the support 44 shown in FIG. 4A, with internal components shown in hidden lines. A perspective view of this embodiment of the invention, with the upper or top portion removed, may also be seen in FIG. 4F.

As can be seen in the FIGS. 4D and 4F illumination sources 45A-45C are positioned in angled channels 42. The channels are angled in a manner which allows illumination sources 45A to define a first distance between the beams of 49A, while illumination sources 45B define a second distance between the beams of 49B. Illumination sources 45C define a third distance between the beams of 49C.

By holding the optical measuring device 10 adjacent the working surface, the distance between the device and the working surface may be adjusted so that the first distance may be varied to outline the damaged area. The second and third distance is determined by fixing the first distance. The respective and relative distance may then be used to determine the respective area of color blending on the working surface.

With this embodiment of the invention, the power source 55 is conventional DC batteries. It is also possible to use conventional AC power sources. An on-off switch 47 may be used to power on the device 10.

The angle of the channels can be seen based upon the angle of facets in the outer wall 14 of the jig 10 and the distance from the individual facets relative to axis Z-Z^{1.}, FIG. 1A. Similarly, the angle of the beams can be seen in FIG. 3C where angles alpha α°, beta β°, and gamma γ° are measured relative to axis X-X¹.

A still even further embodiment of the invention may be seen in FIG. 5 with power sources 55, lasers 56, and supports 54. Similarly to earlier embodiments the device is closed by a top portion (not shown) and bounded by a sidewall not shown. The device may be powered on by a switch 57.

One application for the measuring device of the invention is in surface treatments of automotive parts, surfaces, and body panels. The measuring device of the invention may also be used in any number of other applications where treatments are applied to surfaces. When blending a new surface treatment with an existing surface treatment, the blending distance (or area) varies depending upon any number of factors, discussed earlier. The relative distances, eg. primer area and blending area are set by the dimension of the intended area of treatment.

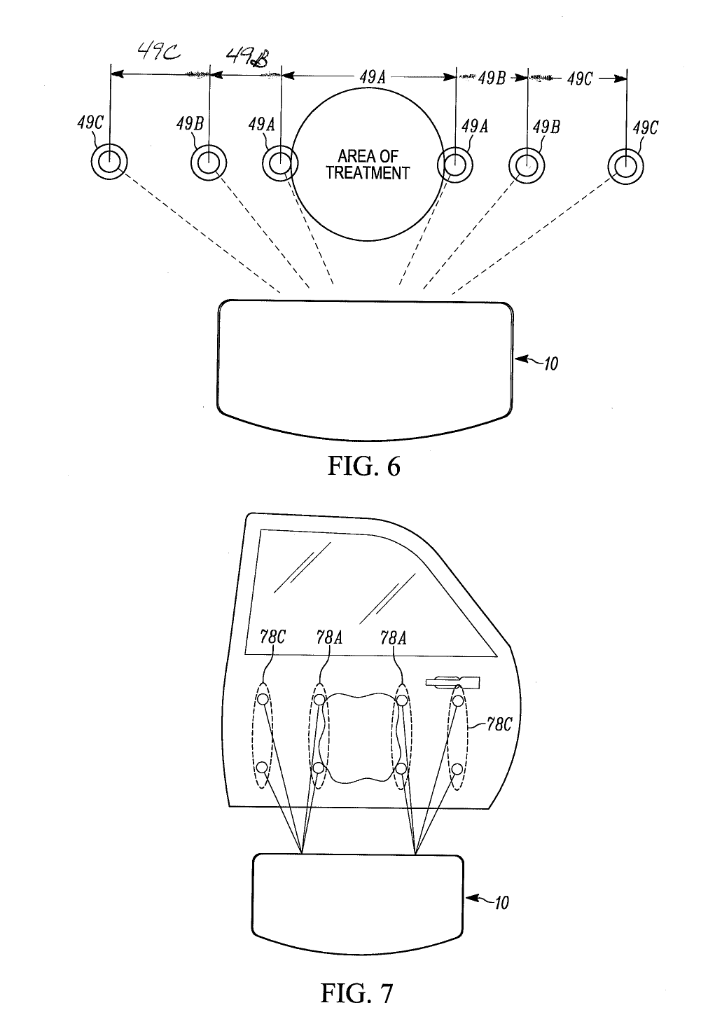

As can be seen in FIG. 6, the area of repair 49A, once determined, also determines the primer area 49B, and blending area 49C. As can be seen in FIG. 6, for purposes of simplicity, the dimension of the primer area is the repair area and the primer area (49A and 49B). The dimension of the blending area is the repair area and the primer area and the blending area, (49A and 49B and 49C). These distances may vary depending on the application and are generally determined by the professional applying the surface treatment. As one of skill in the art realizes having read this specification, primer and blending distances vary depending upon whether the intended surface of treatment is, for example, an auto-body panel or a wall of sheetrock, among other applications. The respective distances; 49A, 49B, and 49C may vary, and often do, depending upon the field of application or construction.

The sources of illumination may take any number of patterns to provide for the repair area, the primer area, and the blending area. In order to make the device of the invention compact and manageable, the illumination sources are generally angled.

Throughout the various embodiments, it can be seen that the sources of illumination are generally in a convergent pattern, (FIGS. 3A-3C), or a divergent pattern, (for example, FIGS. 1A-1C. Regardless of the pattern for the source of illumination, the illumination sources generally have an angle relative to one axis of the device 10 of the invention.

As can be seen in FIG. 1A axis Z-Z¹ provider a base line for measuring angles alpha, beta, and gamma which indicate the relative positioning of each respective illumination source 15 (not shown) in the device. A combination of convergent and divergent patterning may also be used, FIG. 4D. With a convergent illumination pattern, the angle of the illumination sources for representative angles alpha, beta and gamma, may be measured for example from axis X-X^{1,} FIG. 3C. Generally, and for example, the angle of the illumination sources is less than 90° (or less than perpendicular to either axis X-X¹ or Z-Z¹) and greater than 0° or the angle of either axis X-X¹ and Z-Z¹.

The support may have fixed channels 12 or channels which are adjustable to provide for either a specific angle or angles which may be varied across a range. Again, angles alpha, beta, and gamma may vary depending on the application and specifics within that application. In the specific application depicted in FIG. 1A angles alpha, beta and gamma may be varied to vary the distances 49A, 49B and 49C. The exemplary angles depicted in FIG. 3C may be similarly varied.

As mentioned earlier, the support 44, (FIG. 4F), may support the illumination sources 36 through any number of means including the apparent channels 12. The illumination sources may also be secured within the device by other types of supports including glues, sodering or mechanical fixtures among other support mechanisms. The support may also be unitary such as that seen in FIG. 2C supporting all illumination sources in a single structure.

Alternatively, the support may comprise multiple devices or structures, supporting each illumination sources individually. Combinations of support structures may also be used. The support(s) may also be fixed as shown, or adjustable. The individual supports may be made adjustable through the use of glues or soders which are readily dissolvable and re-applied. The individual supports may also be made adjustable through use of mechanical fixtures such as bolts and fasteners, among other fixtures.

The invention is a tool and method that provides a standard operating procedure or protocol for painting repair. The tool is a progressive measuring device. Progressive means the tool will automatically change not only the color blending distance, but also the primer distance quickly and easily based upon the size of the repair. In application, the device may be activated by installing two “AA” batteries. The device is then turned to the “on” position. The invention is then directly pointed at the damaged area. Six illuminated dots appear on the panel. The two inside laser dots are then aligned on each side of the damage. To increase space in between the two inside dots, increase the distance between the panel and the tool. To decrease space, the tool is moved towards the panel. Once the two inside dots are aligned on each side of the damage, the second sets of dots will automatically determine the maximum primer distance. The third sets of dots going outward (which are your furthest dots from left to right) determine your maximum color blending distance, FIG. 6.

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

The claimed invention is:

1. A measuring device comprising:
a first set of illumination sources comprising respective first and second illumination sources for measuring a first distance;
a second set of illumination sources comprising respective first and second illumination sources for measuring a second distance;
a support for said illumination sources;
wherein defining a first distance with said first set of illumination sources defines a second distance with said second set of illumination sources.

2. The device of claim 1, wherein at least one of said first set of illumination sources comprises a laser.

3. The device of claim 1, wherein at least one of said second set of illumination sources comprises a laser.

4. The device of claim 1, additionally comprising a third set of illumination sources for measuring a third distance, wherein defining said first distance with said first set of illumination sources defines said third distance with said third set of illumination sources.

5. The device of claim 3, wherein said support has channels for said third set of illumination sources.

6. The device of claim 4, wherein said respective first, second, and third supports comprises a monolithic structure.

7. The device of claim 1, comprising a base, a top and a sidewall adjourning said base and said top.

8. The device of claim 1, wherein said first and second illumination sources are supported independently.

9. The device of claim 6, wherein said first set of illumination sources comprises at least one laser.

10. The device of claim 6, wherein said second set of illumination sources comprises at least one laser.

11. The device of claim 1, wherein said support has channels for containing said respective first and second sources of illumination.

12. The device of claim 11, wherein said support channels are adjustable.

13. The device of claim 10, additionally comprising a third set of illumination sources for measuring a third distance, wherein defining said first distance with said first set of illumination sources defines said third distance with said third set of illumination sources.

14. The device of claim 10, additionally comprising a third support for said third set of illumination sources.

15. A method of determining a coating protocol using the area of damage, said method comprising the steps of:
a. measuring the area of damage;
b. finding the primer area based on the area of damage; and
c. finding the color blending area based on the area of damages.

16. A method of determining a painting protocol using a laser measuring device, said method comprising the steps of:
a. measuring the area of damage;
b. using that measured area of damage to find a maximum primer area and a maximum color blending area;
wherein said maximum primer and color blending area are determined through laser illumination by a first set of lasers which illuminate said area of damage; by a second set of lasers which illuminate said maximum primer area; and by a third set of lasers which illuminate said maximum color blending area.

17. The method of claim 16, wherein said first, second and third sets of lasers are oriented relative to each other at respective first, second, and third angles from a common axis.

18. The method of claim 17, wherein said first set of lasers oriented at said first angles measurers the area of damage.

19. The method of claim 17, wherein said second set of lasers oriented at said second angles finds said maximum primer area.

20. The method of claim 17, wherein said third set of lasers oriented at said third angles finds said maximum paint blending area.
